(19) United States
(12) Patent Application Publication
(10) Pub. No.: US 2013/0010461 A1
(43) Pub. Date: Jan. 10, 2013

(54) Ballast Bypass Harness Assembly For Use With A Light Emitting Diode Fluorescent Tube Replacement Bulb

(75) Inventor: Gregg Wilson, Goleta, CA (US)

(73) Assignee: STARLIGHTS, INC., Goleta, CA (US)

(21) Appl. No.: 13/543,258

(22) Filed: Jul. 6, 2012

Related U.S. Application Data
(60) Provisional application No. 61/505,525, filed on Jul. 7, 2011.

(51) Int. Cl. F21V 19/00

(52) U.S. Cl. 362/217.17

(57) ABSTRACT

A flexible ballast bypass power harness assembly for LED fluorescent tube replacement bulb for unique and exclusive new way of powering a light emitting diode fluorescent tube replacement bulb by only using the bulb plug ends to hold the Bulb in the fixture only, the power will be supplied by the harness, thus saving the time and effort to rewire and remove the ballast from the fixture. The flexible ballast bypass power harness for LED fluorescent tube replacement bulbs generally includes a wiring harness and separable electrical plug.

### CROSS REFERENCE TO RELATED APPLICATION

This application claims the benefit of U.S. provisional patent application No. 61/505,525 filed on Jul. 7, 2011, entitled “FLEXIBLE BALLAST BYPASS POWER HARNESS FOR LIGHT EMITTING DIODE FLORESCENT TUBE REPLACEMENT BULB,” the entire contents of which is incorporated by reference.

### FIELD OF THE INVENTION

The present invention relates generally to LED replacement bulbs and more specifically to a flexible ballast bypass power harness for use with a light emitting diode fluorescent tube replacement bulb.

### BACKGROUND OF THE INVENTION

Tubular LED replacement bulbs are well known in the art however these typically must be used with a specialized fixture. Accordingly, alternative LED assemblies and methods would be advantageous to the consumer without the necessity to purchase a specialty fixture to correctly operate the replacement bulb.

### BRIEF DESCRIPTION OF THE DRAWINGS

FIG. 1 is a side view showing the hole grommet, installed in the exit hole in the light emitting diode fluorescent tube replacement bulb.

FIG. 2 is a side and partial cross-sectional view taken along section lines “A-A” shown in FIG. 1.

FIG. 3 is side view illustrating the lower wiring harness separable from the upper wiring harness using an electrical connector or plug.

These and other features, advantages, and objects of the present invention will be further understood and appreciated by those skilled in the art by reference to the following specification, claims, and appended drawings.

### DETAILED DESCRIPTION

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

Turning now to the drawings, in which similar reference characters denote similar elements throughout the several views, FIG. 1 is a side view showing the hole grommet, installed in the exit hole in the light emitting diode fluorescent tube replacement bulb. A ballast bypass harness assembly 100 includes a tubular LED lamp 101, a first or “upper” wiring harness 110, a second or “lower” wiring harness 120, hole grommet 130, and electrical plug 140. Both the upper wiring harness 110 and lower wiring harness 120 may be flexible with a wire gage size large enough to supply the required voltage and current to the light emitting diode fluorescent tube replacement bulb. The upper wiring harness 110 and lower wiring harness 120 may include sheath insulation and/or insulative covering sufficiently strong enough to protect the wiring from cuts from sharp edges during the installation and operation of the LED fluorescent tube replacement bulb 101.

The upper wiring harness 110 is constructed of sufficient size and/or gage wire so as to be able to supply the LED tube replacement bulb 101 with the required voltage and current to function properly. This prevents a thermal heating problem of the harness assembly while allowing it to remain flexible to bend around tight corners or other objects. The harness 110 is typically covered with a sheath and/or insulator constructed of a material(s) that with allow the harness to remain flexible but at the same time giving the harness protection from sharp edges and other dangerous conditions.

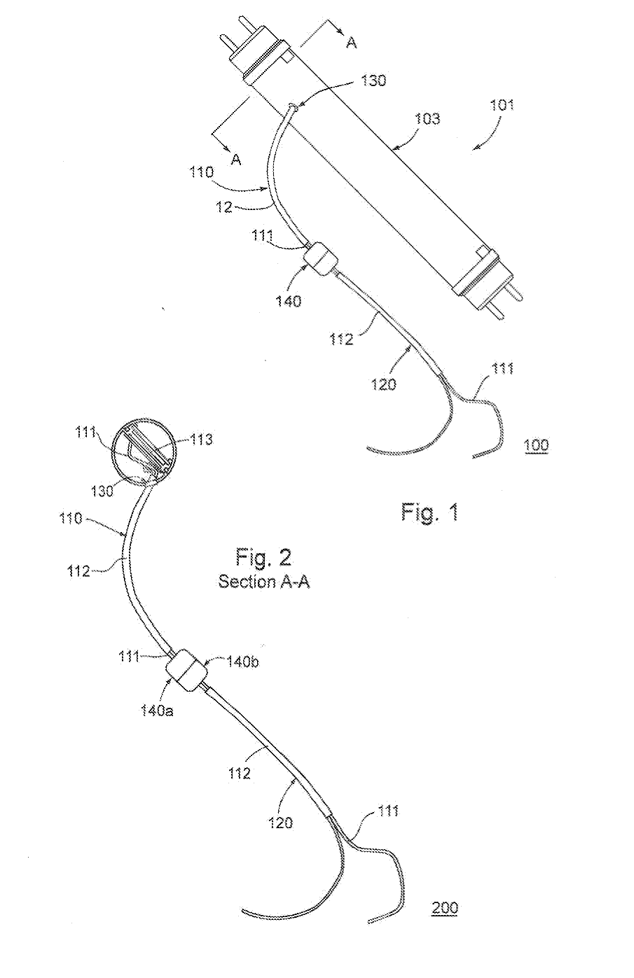

FIG. 2 is a side and partial cross-sectional view taken along section lines “A-A” shown in FIG. 1. The wiring harness assembly 200 includes wires 111 that are connected to the LED printed circuit board (PCB) driver 113, inside the LED tube lamp. The wires 11 are used from supplying the power that heretofore was supplied by the end plugs mounted on each end of a fixture (not shown). The LED PCB driver 113 includes one or more LEDs or other light sources that are positioned in a manner so they may be fastened to a housing under the bulb cover 103. The LED PCB driver 113 can extend along the entire longitudinal length of the bulb cover 103 or only a portion thereof. Those skilled in the art will recognize that LED tube lights do not require a ballast to start and/or energize the bulb as do the standard fluorescent bulb type lamps. The ballast typically supplies electrical power at a substantially high voltage and would harm the electronics of the light emitting diode fluorescent tube replacement bulb if this voltage were applied to the LED replacement bulb.

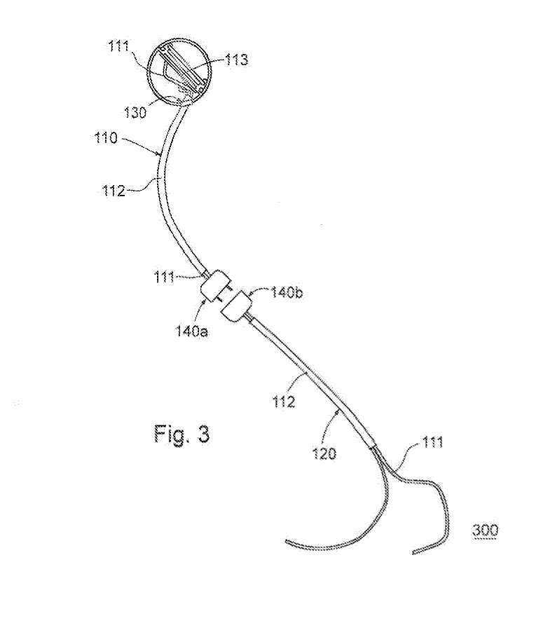

FIG. 3 is side view illustrating the lower wiring harness separated from the upper wiring harness using an electrical connector or plug 140a, 140b. The wiring harness assembly 300 illustrates the harness plug 140a, 140b that is used to separate the upper harness 110 from the lower harness 120. This separation works to make the installation process easy and uncomplicated since the LED fluorescent tube replacement bulb 101 can be replaced without the hanging harness being a nuisance to other objects and/or obstructing the installers view.

Thus, the LED fluorescent tube replacement bulb 101 can be suspended and/or hung from the harness during the installation process. By passing the upper harness 110 through the hole in grommet 130, the upper wiring harness 110, will be protected from any sharp edges on the top or bottom of the hole that was drilled through the tube allowing the upper wiring harness 110, to exit the inside tube area. Once the lower harness 120, has been connected to the fixture, the upper harness 110 can be connected to the lower harness 120 by way of the plug 140a, 140b. Although other types of plugs can be used, the plug 104a typically is a male electrical connector while plug 104b is a female electrical connector. This provides a powered connection to the LED fluorescent tube replacement bulb 101 that is separable such that it can be plugged and or unplugged into the fixture and the installation or disassembly.

Thus, embodiments of the invention as described herein allow the user to utilize an LED replacement bulb without the burden of re-wiring the fixture and removing the ballast. In the future, should the owner or user wish to return the fluorescent tubes, this can easily be accomplished without the need to rewire the fixture as the original ballast has not been removed. The wires 112, on the lower portion of the harness 120, opposite the upper harness 110, attach and/or engage with the LED fluorescent tube replacement bulb to both electrical ground and a power source for energizing the LED bulb. Those skilled the art will further recognize that standard 120 volt AC or 12 volt DC power sources may be used.

Hence, an embodiment of the invention allows those who own fluorescent fixtures with the traditional fluorescent lamps a method to easily retrofit those fixtures without having to replace them. The decision to migrate to LED tube replacement bulbs is costly, however it offers great advantages such as longer operational life upwards of 100,000 hours. Thus, the method of the present invention allows the fluorescent lamps to be retrofit or replaced with bulbs operating in a fluorescent fixture with little effort.

The installation process involves connecting the harness ground and positive power wires which enter the back or side of the fixture. Once located, the wires can be cut to size and the ends stripped leaving one inch attached to the old ballast in the event the fixture is to be reused later with a fluorescent tube replacement. The power and ground wires are attached to the lower wiring harness 120. Once connected, the ballast cover can be reinstalled leaving the plug 140 and approximately 1 inch (25.4 mm) of harness wire 111, with the protective cover 120, protruding from under the cover. The light emitting diode fluorescent tube replacement bulb is then installed into the fixture using the end plugs as is customary and usual. Thereafter, the upper wiring harness 110 is reattached to the lower wiring harness 120 using the plug 140 and the installation is complete.

The upper harness can be constructed with or without an electrical connector or “plug”. Moreover, the harness assembly can be constructed using wires with heavy insulation negating the need of the protective covering sheath. The wires may be attached to one another as with a standard #16 house lamp cord. Alternatively, an electrical connector could be installed on the LED tube allowing the wiring harness to easily be connected.

The lower wiring harness preferably will be flexible having a gage size large enough to supply the required voltage to the light emitting diode fluorescent tube replacement bulb, with a sheath covering sufficiently strong enough to protect the wiring from cuts or sharp edges during the installation and operation of the light emitting diode fluorescent tube replacement bulb. Further, the lower wiring harness will be constructed of sufficient gage wire so as to be able to supply the light emitting diode fluorescent tube replacement bulb with the required voltage and current to function properly and so as not to create a thermal heating problem of the harness but remain flexible to bend around tight corners. It shall be covered with a sheath constructed of a material that with keep the harness flexible but at the same time giving it protection from sharp edges and other avert conditions. The lower harness can be constructed with several detectable and/or separable electrical connectors. The harness can be constructed using multi-conductor wire with substantially heavy insulation negating the need of the protective covering sheath. The wires can be molded or mechanically attached to each other as with a standard house lamp cord also sometimes known as “zip” cord.

The grommet or protective bushing is of sufficient size that it will protect the harness from the sharp edge of the exit hole in the light emitting diode fluorescent tube replacement bulb and have a substantial grip on the tube walls so as not to come lose and subjecting the harness to the sharp edges. The grommet should be sized to tightly fit the circumference of the harness protective cover and/or wire jacket. Alternatively, the grommet hole can be an elongated slot or channel allowing the grommet or other bushing to be uniquely positioned at a predetermined position on the cover bulb cover 103. This will allow the harness 104a to be oriented in a manner so as the harness 104a exits the hole to keep it clear from other wiring and from being a nuisance to the user. Alternatively, those skilled in the art will recognize a plurality of grommet holes can positioned in the bulb cover 103 and may be in the form of perforated punch-outs so the user can preselect the exit position of the harness 104a and position of the grommet and harness for easy hook-up to a power source.

Use of a grommet requires its side walls of sufficient size so as to grip the inside and outside of the tube. This allows the area on the inside of the grommet to remain moisture resistant. Since the hole has been made in the tube at a predetermined size and position, the harness is tensioned within the grommet so the grommet will not migrate from the hole nor will the harness be comprised to sharp edges or the interior of the LED fluorescent tube replacement bulb to moisture. The positioning of the hole is typically several inches (greater than 50 mm) from an end of the LED fluorescent tube replacement bulb so to facilitate easy connection of the harness while keeping it away from the center of the bulb cover 103. Although not shown, those skilled in the art will recognize that the upper wiring harness may also exit though an end or side of the end plugs located at an end of the LED fluorescent tube replacement bulb.

In an alternative embodiment, the hole grommet can also be replaced with a silicon type glue suitable for the intended use if the hole were be deburred of all sharp edges. The electrical plug will be placed at a distance from the tube exit hole to give the LED fluorescent tube replacement bulb the correct amount of slack and/or play to be properly mounted. The electrical plug shall also be of sufficient size to carry an electrical load sufficient enough to power the LED fluorescent tube replacement bulb. The plug will be constructed of sufficient size so as to be able to supply the LED tube with the required voltage and current to function properly and so as not to create issues regarding thermal overheating in the plug. The plug may also utilize a locking device that once connected will hold the plug in a rigid electrical connection. In one embodiment, the plug or connector will need to be squeezed by pressing on the locking device to disengage the plug body.

There has described features of the invention in order that the detailed description thereof may be better understood, and in order that the present contribution to the art may be better appreciated. There are additional features of the invention are described herein. An object of the invention is to provide a flexible ballast bypass power harness for LED fluorescent tube replacement bulb for an inventive way of powering a light emitting diode fluorescent tube replacement bulb by using only the bulb plug ends to hold or secure the bulb in the fixture. The power is supplied using a bypass harness assembly instead of the bulb plug ends, thus saving the time and effort to rewire and remove the ballast from the fixture.

Another object of the invention is to provide a flexible ballast bypass power harness for that can be used to by-pass the factory installed ballast. While still another object of the invention is to provide a replacement LED bulb that has a plug in the middle for allowing the harness to be installed without having the weight of light emitting diode fluorescent tube replacement bulb hanging on the harness. Still another object of the invention is to provide an LED replacement bulb that is covered with a protective sheath to protect the power wires from being cut on any sharp edges inside the fixture. Still another object of the invention is to provide a replacement LED bulb that is long enough to provide for the installation but short enough to be hidden under the ballasts cover.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

We claim:

1. A ballast bypass harness assembly comprising:
a tubular lamp having a bulb plug at each end of the tubular lamp;
a first wiring harness extending from a portion of the tubular lamp;
a second wiring harness for attachment to the first wiring harness;
a detachable connector for electrically connecting the first wiring harness and second wiring harness; and
wherein the first wiring harness and second wiring harness provide power for illuminating the tubular bulb.

2. A ballast bypass harness assembly as in claim 1, wherein the bulb plug operates to provide only a mechanical connection for the tubular lamp for holding the lamp in a fixed position.

3. A ballast bypass harness assembly as in claim 1, wherein the tubular lamp is illuminated using light emitting diodes (LEDs).

4. A ballast bypass harness assembly as in claim 1, wherein the bulb plug provides no electrical connection to a lamp fixture.

5. A ballast bypass harness assembly as in claim 1, wherein the first harness and second harness is flexible.

6. A ballast bypass harness assembly as in claim 1, wherein the LEDs operate on 120 vac or 12 vdc.

7. A flexible ballast bypass harness assembly comprising:
a tubular LED lamp having a body and a bulb plug positioned at each end of the body for providing support of the tubular LED lamp in a lamp fixture;
a lamp fixture for providing support to the bulb plug;
at least one wiring harness extending from the body of the tubular LED lamp;
a connector for electrically separating the at least one wiring harness; and
wherein the at least one wiring harness provides electrical power for illuminating the tubular LED lamp.

8. A ballast bypass harness assembly as in claim 7, wherein the bulb plug provides no electrical connection to the tubular lamp.

9. A ballast bypass harness assembly as in claim 7, wherein the at least one wiring harness includes jacketed wire.

10. A ballast bypass harness assembly as in claim 7, wherein the jacketed wire is flexible.

11. A ballast bypass harness assembly as in claim 7, wherein the LEDs operate on 120 vac or 12 vdc.

12. A method for providing power to a LED bulb using a ballast bypass harness assembly comprising the steps of:
providing a tubular LED lamp having a bulb plug at each end;
providing a wiring harness extending from a portion of the tubular lamp;
utilizing a detachable connector for electrically connecting portions of the wiring harness; and
bypassing the bulb plug using a wiring harness for providing power to illuminate the tubular bulb.

13. A method for providing power to an LED bulb as in claim 12, further comprising the step of:
utilizing the bulb plug to provide only a mechanical connection for the tubular lamp for holding the lamp in a fixed position.

14. A method for proving power to an LED bulb as in claim 12, further comprising the step of:
illuminating the tubular lamp using light emitting diodes (LEDs).

15. A method for providing power to an LED bulb as in claim 12, further comprising the step of:
utilizing the bulb plug to provide only a mechanical connection to the tubular lamp.

16. A method for providing power to an LED bulb as in claim 12, further comprising the step of:
utilizing flexible wire for the harness.

17. A method for providing power to an LED bulb as in claim 12, further comprising the step of:
operating the tubular LED lamp on 120 vac or 12 vdc.
